(19) United States
(12) Patent Application Publication
(10) Pub. No.: US 2008/0311259 A1
(43) Pub. Date: Dec. 18, 2008

(54) High pressure pasteurization of liquid food product

(76) Inventors: Prem S. Singh, Glen Ellyn, IL (US); Frederick Cook, Omaha, NE (US); James Costelloe, Naperville, IL (US); Deijing Fu, Lisle, IL (US)

Correspondence Address: SUITER SWANTZ PC LLO, 14301 FNB PARKWAY, SUITE 220, OMAHA, NE, 68154, US

(21) Appl. No.: 11/818,895

(22) Filed: Jun. 15, 2007

(51) Int. Cl. A23L 3/34; A23L 3/015; B01J 19/00

(52) U.S. Cl. 426/330; 426/521; 99/467

(57) ABSTRACT

The present invention is a method for pasteurization or sterilization of liquid food products using high pressure in a continuous or semi-continuous flow. The invention involves pressurizing and depressurizing the liquid product for a sufficient duration of time to achieve a 2.5 log cycle reduction in microorganisms. The uniform application of high pressure to the liquid food product coupled with a controlled pH and temperature of the liquid food product, the setting and maintaining the pressurizing media temperature, and the rapid depressurization resulting in cellular disruption of the microorganisms within the liquid product inactivating or destroying the microorganisms, such as vegetative microorganisms, while preserving the functionality of the liquid product.

### FIELD OF THE INVENTION

The present invention generally relates to the field of non-thermal microbial inactivation of liquid food products, and more particularly to non-thermal pasteurization.

### BACKGROUND OF THE INVENTION

Food processing involves the transformation of raw animal or plant materials into consumer-ready products, with the objective of stabilizing food products by preventing or reducing negative changes in quality. To consumers, the most important attributes of a food product are its sensory characteristics (e.g. texture, flavor, aroma, shape and color). These determine an individual's preference for specific products. A goal of food manufacturers is to develop and employ processing technologies that retain or create desirable sensory qualities or reduce undesirable changes in food due to processing. PHysical (e.g. heating, freezing, dehydration, and packaging) and chemical (e.g. reduction of pH or use of preservatives) preservation methods continue to be used extensively and continue to evolve at a rapid rate in order to improve the efficiency and effectiveness of these processes. The most common method of food preservation used today is thermal treatment (e.g. pasteurization, sterilization). Although heating food effectively reduces levels of microorganisms, such as vegetative microorganisms, such processing can alter the natural taste and flavor of food and destroy vitamins.

Consumer-oriented food products and modified food products for preparing popular dished that have the properties of fresh ingredients are highly desirable for their economy, high nutrition, convenience, and appeal as a food. Moreover, these food products, which include discrete flavored particles, i.e. pieces, that are added to the food product before cooking to enhance and modify the natural food product and provide discrete zones of independent natural flavor, texture, shape, and color. However, the effects of thermal pasteurization on such combinations contain major drawbacks, i.e. it may lose the texture, consistency and mouth feel of discrete particle in the food product. When food products and modified food product in accordance with the present invention, these drawbacks are avoided.

Several alternatives to thermal inactivation of micro-organisms exists, such as microwaves, infrared, ultra violet, gamma radiation, ionized radiation, E-beam radiation, high intensity laser or non coherent light pulses, ultrasound, ohmic heating, pulsed electric fields, high voltage electric discharges, bacterial enzymes, mild heat with slight pressurization, extrusion cooking, high pressure batch processing, high pressure throttling, and combinations of such.

Microbial inactivation by high pressure (“HP”) is the result of a combination of factors. The primary site for pressure-induced microbial inactivation is the cell membrane (e.g. modification in permeability and ion exchange). Microorganisms are resistant to selective chemical inhibitors due to their ability to exclude such agents from the cell, mainly by the action of the cell membrane; however, if the membrane becomes damaged, this tolerance is lost. In addition, HP causes changes in cell morpHology and biochemical reactions, protein denaturation and inhibition of genetic mechanisms. Other mechanisms of action, which may be responsible for microbial inactivation, include the denaturation of key enzymes and the disruption of ribosomes.

High pressure micro-organism inactivation through high pressure is effective for certain applications, the technology has the disadvantages of being a batch process with long process times due to the pressurization and depressurization of the vessel combined with the loading and unloading of the contents. In an effort to overcome these disadvantages, investigators have developed pulse-type mechanisms, which are essentially multiple batch processes that fill and evacuate in a throttling manner as to provide a continual flow of post-pressurized product. This type of system is mechanically intensive and economically laborious.

Therefore, it would be advantageous to devise a method of assuring the protections of pasteurization, maintaining the desired functionality of a liquid food product, such as liquid egg product, and to improve the commercial feasibility of the process.

### SUMMARY OF THE INVENTION

Accordingly, the present invention involves a method and an apparatus for using high pressure to ensure microorganism, such as vegetative microorganism, inactivation in liquid products, and in particular liquid egg products. The product is subjected to high pressures of approximately 70,000 to 87,000 pounds per square inch (psi). This high pressure coupled with adjusting the temperature of the pre-pressurized food product, to the desired temperature, adjustment of pH of the pre-pressurized food product, to the desired pH, and maintaining a desired temperature of the pressurizing media disrupts the cellular function of the microorganisms, such as vegetative microorganisms, causing death or inactivation of the microorganism.

High pressure pasteurization (“HPP”), also known as high hydrostatic pressure processing or ultra-high pressure processing, is to be used to pasteurize egg white, whole eggs, egg substitutes, and egg yolk at elevated pressures of approximately 70,000 to 87,000 pounds per square inch (“psi”) at a specified temperature and for a specified time. The pressure within the chamber is created via a reduction in the pressure chamber volume or a positive displacement of the pressurizing material. Under these conditions, HPP has been found to be effective in inactivating many microorganisms, such as vegetative microorganisms, commonly found in foods. As compared to canned foods or conventionally pasteurized juices and milk, HPP significantly reduces the process temperature and time, which results in foods with improved characteristics such as better retention of freshness, flavor, texture, color, and nutrients.

Demand for products that appeal to consumer sensory perceptions such as aroma, texture, color, shape, and flavor equate to fresh and wholesome food. The Isostatic Rule is applicable to High Pressure Pasteurization and states that pressure is instantaneously and uniformly transmitted throughout a sample under pressure, whether the sample is in direct contact with the pressure medium or hermetically seated in a flexible package that transmits pressure. Pressure is transmitted in a uniform (isostatic) and quasi-instantaneous manner throughout the sample; the time necessary for pressure processing is therefore independent of sample size, in contrast to thermal processing.

The present invention provides consumers with the safety of pasteurization in a product where the individual components of combined food products retain their natural characteristics despite the combination. For example, in a liquid egg product it may be desirous to add cheese to the egg product. However, the use of thermal pasteurization will change the characteristics of the egg and the cheese creating a mushy non-natural looking product. This non-natural product may lack the taste, texture, shape and color that the consumer comes to expect. Additionally, thermal processing may reduce the moisture of the ingredients and thus the size of the food particle within the egg product.

The use of high-pressure pasteurization eliminates the need for maintaining particle size in order to achieve adequate pasteurization of additional food ingredients. Therefore, the addition of chunk cheese, whole vegetables, or meat pieces to a liquid egg product is equally pasteurized regardless of particle size.

In the present invention, the waste associated with plate degradation of the food product is eliminated due to the consistent pressure and thus pasteurizing of the food product despite distribution of the product within the chamber. Because of the uniformity of effect created by the High Pressure there is no over or under processing of the food material. Therefore, no additional validation is required when adding food components in combination prior to pasteurization.

The present invention involves preparing the food product, such as liquid egg product, as to pH and temperature, heating the pressurizing media to a desired temperature, subjecting the product to pressures up to 87,000 psi, and then rapidly depressurizing the pressurizing chamber or removing the food product from the high-pressure environment. The high pressure coupled with a rapid return to ambient pressure destroys microorganisms, such as vegetative microorganisms, by interrupting their cellular functions. Within a living bacteria cell, many pressure sensitive processes such as protein function, enzyme action, and cellular membrane function are impacted by high pressure resulting in the inability of the bacteria to survive. While small macromolecules that are responsible for flavor, aroma, and nutrition are typically not changed by pressure additional sensory perception may still be impacted by high pressure. In particular are the effects on liquid egg products. Liquid egg white partially coagulates when treated at pressure greater that 500 MPa, and strong self-supporting gels are formed at pressure higher than 600 MPa. However the hardness and elastic modulus of the gels remained significantly lower than those of gels obtained by heat treatment, or by longer pressurization times. The present invention utilizes pH and temperature to accentuate the effects of high-pressure on microorganisms and minimize the effects on protein and lipid components of the food product, such as liquid egg product through a reduction in pressurization times.

The liquid product will be subjected to the high pressure environment via a continuous or semi-continuous flow.

### BRIEF DESCRIPTION OF THE DRAWINGS

The numerous advantages of the present invention may be better understood by those skilled in the art by reference to the accompanying figures in which:

FIG. 1 is a diagram illustrating a method for pasteurizing material using high-pressure in accordance with an exemplary embodiment of the present invention;

FIG. 2 is a side elevation view of a semi-continuous or continuous high-pressure pasteurization apparatus in accordance with an exemplary embodiment of the present invention.

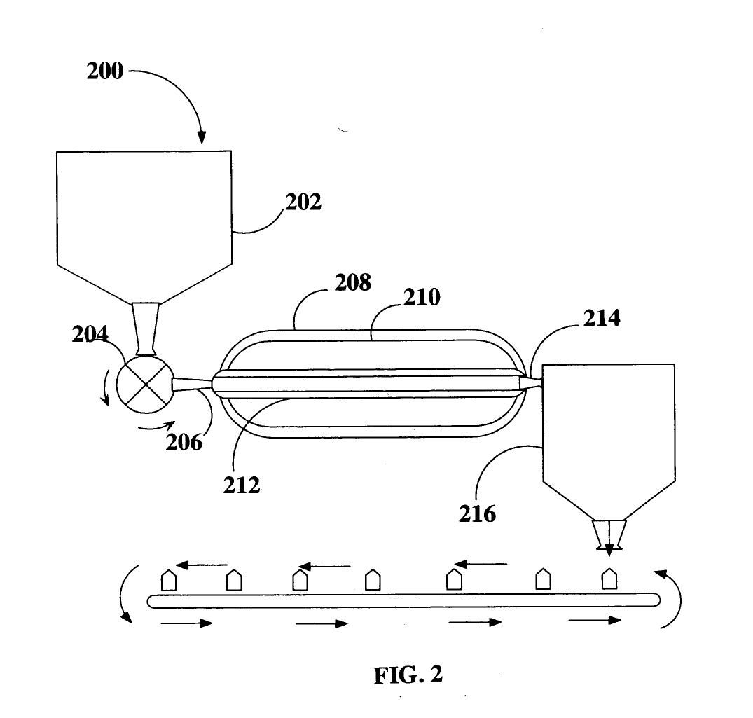

FIG. 3 is a side elevation view of a pre-packaged high-pressure pasteurization apparatus in accordance with an exemplary embodiment of the present invention.

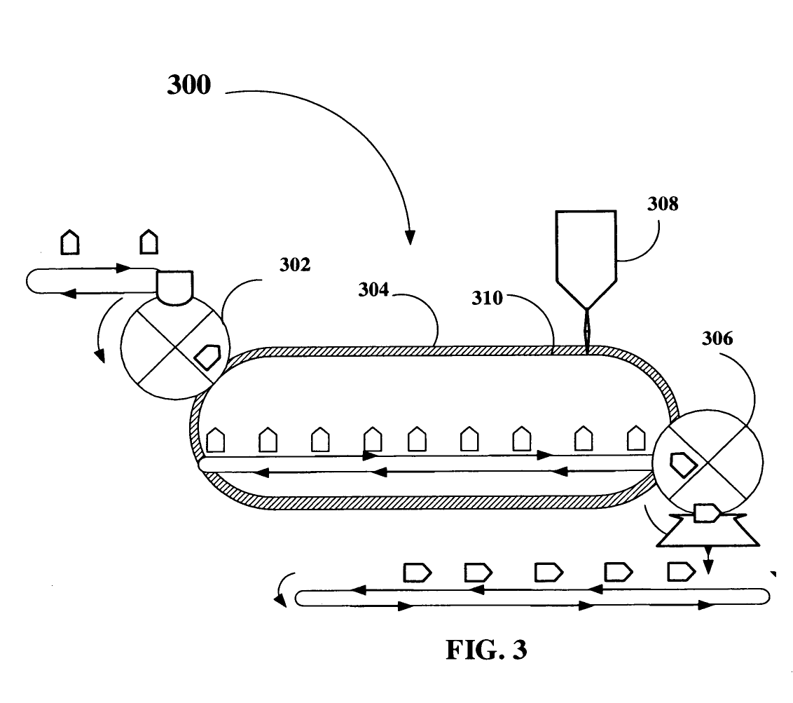

### DETAILED DESCRIPTION OF THE INVENTION

It is believed that the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

It will be appreciated by those skilled in the art that liquid and non-liquid egg products pose unique problems during pasteurization resulting from changes to lipid and protein content of the egg products. Albumen represents an extensively used food ingredient, mostly because of its functional properties. The gelling, emulsifying, and foaming properties of fresh albumen are fundamental for the production and for assessing the final properties (texture, flavor, etc.), of many foods. However, most of the functional properties of egg albumen are lost or modified after even the mildest heat treatments (such as pasteurization), that are normally used for the sanitation of egg components. Moreover, the use of high pressure, for pasteurization of egg products, sufficient to achieve the desired vegetative microorganism inactivation likewise has unique problems. While the pressure-treated egg products retain their natural flavor and nutritional values other sensory perceptions are changed. Liquid egg white partially coagulates when treated at pressure greater that 500 MPa, and strong self-supporting gels are formed at pressure higher than 600 MPa. However the hardness and elastic modulus of the gels remained significantly lower than those of gels obtained by heat treatment, or by longer pressurization times. The present invention utilizes pH and temperature to accentuate the effects of high-pressure on microorganism, such as vegetative microorganisms and minimize the effects on protein and lipid components of the food product, such as liquid egg product.

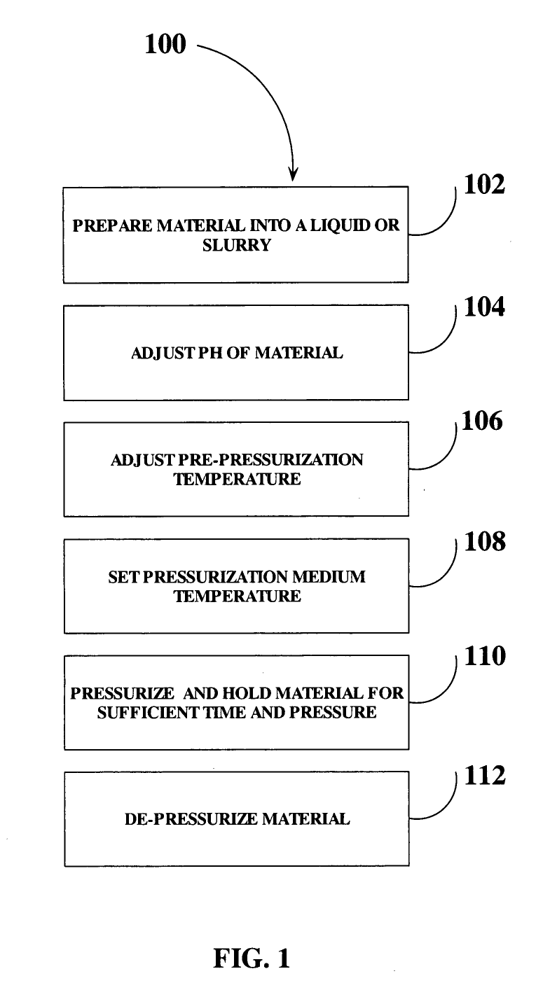

Referring generally to FIG. 1, a method of pressure processing a material is shown. In a present embodiment, the method 100 includes preparing a material into at least one of a liquid or slurry 102. The material described in the method is a liquid egg product. The liquid egg product includes at least one nutritional ingredient. The method 100, includes adjusting the pH of the food material to a range between 4.0 and 9.0 (104). Additionally the method 100, prescribes that the temperature, at normal atmosphere, of the liquid egg product be between 40 degrees Fahrenheit and 120 degrees Fahrenheit and the slurry be at between 40 degrees Fahrenheit and 160 degrees Fahrenheit prior to placement in the pressure chamber 106.

In a present embodiment, the pressurizing media is set to a defined temperature 108. The food product is placed into a pressurization chamber where a pressurizing material is pressurized 110. Examples of pressurizing material include liquid or gas. The pressurizing media is set and maintained at a temperature of 40 degrees Fahrenheit and 120 degrees Fahrenheit. The method for achieving the pressurization may include reducing the area of the pressure chamber or expanding the content volume within the chamber. The method 100, includes the de-pressurization of the food material 112.

In an embodiment of the present invention, the food material is in a liquid form. The pH of the liquid material is adjusted to a desired pH of between 4.0 and 9.0. The pH is adjusted with the use of NaOH and HCL, however other chemicals may be used for this purpose. For example, KOH may be utilized in place of NaOH.

In further embodiments, the addition of antimicrobial agents such as Acetates, Benzoates, Diacetates, Dimethyl Dicarbonate, Lactates, Nitrates, Propionates, Sorbates, Sulfites, and carbon dioxide further enhance the effects of high pressure pasteurization. The effects of the antimicrobial agents are synergistically enhanced by the high pressure processing.

In further embodiments, the temperature of the pressurizing material is maintained between 40 degrees Fahrenheit and 120 degrees Fahrenheit (At normal atmosphere).

In the present embodiment, as the pressure is exerted on the liquid product within the pressure vessel the resulting high pressure is transferred to the food product and disrupts the cellular function of the microorganism, such as vegetative microorganisms. This results in the destruction or inactivation of microorganism, such as vegetative microorganisms, achieving a 2.5 to 3.0 log reduction in microorganism, such as vegetative microorganisms in the liquid product.

In a further embodiment, the food material is subjected to the desired high pressure for a time sufficient to kill or deactivate the desired pathogens present. In a current embodiment of the invention, the pressure within the chamber is between 70,000 psi and 87,000 psi. In a current embodiment, the time necessary to achieve a 3.0 log reduction on a liquid egg product is between 4 and 6 minutes.

Table 1 illustrates the effect of HPP on Listeria species at 70,000 psi for 4 minutes:

TABLE 1

| Sample | | Counts | Log Decrease following |
|---|---|---|---|
| Description | Processed | (cfu/g)* | processing |
| Pasteurized egg | No | 8.5 × 10⁴ | |
| Pasteurized egg | Yes | <100 | >2.92 |
| Un-pasteurized egg | No | 6.8 × 10⁴ | |
| Un-pasteurized egg | Yes | <100 | >2.83 |

*Refers to duplicate samples

Table 2, illustrates the effect of HPP on Salmonella species at 70,000 psi for 4 minutes:

TABLE 2

| Sample | | | Log Decrease |
|---|---|---|---|
| Description | Processed | Counts (cfu/g)* | following processing |
| Pasteurized egg | No | 1.50 × 10⁵ | |
| Pasteurized egg | Yes | <100 | >3.18 |
| Un-pasteurized | No | 8.25 × 10⁵ | |
| egg | | | |
| Un-pasteurized | Yes | <100 | >3.92 |
| egg | | | |

*Refers to duplicate samples

Table 3, illustrates the effect of HPP on Bacillus subtilis at 87,000 psi for 4 minutes:

TABLE 3

| | Preprocess | Processing | Counts (cfu/g)* | Counts | |
|---|---|---|---|---|---|
| Sample | Product | Water | Before | (cfu/g)* After | Log |
| Description | Temperature | Temperature | processing | Processing | Decrease |
| Slurry pH | 40 | 40 | 5.85 × 10⁵ | 7.35 × 10⁵ | −0.1 |
| 4.6 | 120 | 120 | 5.50 × 10⁵ | 4.55 × 10⁴ | 1.1 |
| (pH | 160 | 120 | 2.70 × 10⁵ | 4.50 × 10² | 2.78 |
| adjusted | | | | | |
| with HCL | | | | | |
| Slurry pH 6 | 40 | 40 | 5.30 × 10⁵ | 3.65 × 10⁵ | 0.16 |
| | 120 | 120 | 4.45 × 10⁵ | 5.10 × 10⁵ | −0.06 |
| | 160 | 120 | 4.20 × 10⁵ | 6.50 × 10³ | 1.81 |
| Slurry pH 9 | 40 | 40 | 7.50 × 10⁵ | 4.75 × 10⁵ | 0.2 |
| (pH | 120 | 120 | 5.70 × 10⁵ | 6.75 × 10⁴ | 0.93 |
| adjusted | 160 | 120 | 4.55 × 10⁵ | 4.15 × 10⁴ | 1.04 |
| with NaOH | | | | | |

*Refers to duplicate samples

In a further embodiment the food product is egg white, whole egg, or egg product with or without additional ingredients such as dairy, vegetable, and meat products.

A further embodiment is directed to an apparatus for subjecting a liquid or slurry material to high pressure in a pulse, semi-continuous, or continuous flow. Examples would include the use of liquid, gas, or mechanical means to create pressure within a pressure chamber.

In a further embodiment the liquid material is held in a mixing and holding tank or chamber 202, which is connected to a positive displacement pump 204. The positive displacement pump includes an inlet, which is at ambient pressure and a outlet, which is at high pressure. The outlet of the positive displacement pump is constructed with a pressure valve and attachment 206, to attach to a pressure chamber. In one example the positive displacement pump pumps liquid material into the pressure chamber and continues to fill the pressure chamber until a desired pressure is achieved. Upon achieving the desired pressure within the chamber, the liquid material is maintained at said pressure for a defined period. Upon reaching the defined time limits a high pressure valve allows for escape of the liquid material at a rate consistent with the pumping speed of the positive displacement pump such as to maintain the time and pressure for the deactivation of the micro-organisms within the liquid material.

In an additional example, the liquid material is pumped through a tube 212, which is constructed within the high-pressure chamber 208. A resilient membrane 210, within the pressure chamber reduces the volume of the chamber and causes a pressurizing media to exert a defined amount of pressure on the tube within the chamber. The tube, which contains the liquid material remains pliable and thus as the liquid material is coursing the tube it is subjected to the same pressure as the tube. The liquid material then exits the tube through a reduced orifice, or high pressure valve 214, to maintain the integrity of the tube while time and pressure limits are met. The liquid material undergoes rapid de-pressurization upon exiting the tube and returns to ambient pressure. The high-pressure valve is attached to a sterile fill chamber 216, which receives the pasteurized liquid material from the high-pressure chamber container.

In a further embodiment, the food product is pre-packaged and the package and contents are introduced to the pressure chamber 304, via a first star valve 302. The first star valve 302 is in contact with the pressure chamber creating a air tight seal which, when the first star valve 302 is rotated, the packaged food product falls to a moving system that transports the packaged food product to a second star valve 306. The second star valve 306, is in contact with the pressure chamber 304 to allow for evacuation of the packaged food product following the pressurization cycle. The pressurizing media may be gas or liquid and is maintained at pressure via a reduction of volume within the high pressure chamber container, such as a resilient bag or a positive displacement pump that receives pressurizing material from external holding tank 308. The pre-packaged food product is thus subjected to the pressurizing media, thereby upon pressurization of the chamber the contents of the package follow the Isostatic Rule.

What is claimed:

1. A method of pressure processing a food product, comprising: preparing a material into at least one of a liquid or slurry; adjusting a pH of the material;
preprocessing the material to a predefined temperature;
setting and maintaining the pressurizing media to a defined temperature;
pressurizing material at a sufficient pressure and for a sufficient time to achieve pasteurization of the food product white not denaturizing the protein component of the food product;
depressurizing the material resulting in at least a 2.78 log cycle reduction in a number of viable organisms in the material.

2. The method as claimed in claim 1, wherein the food product is liquid egg white or whole egg products.

3. The method as claimed in claim 2, wherein the food product includes at least one nutritional ingredient.

4. The method as claimed in claim 1, wherein the pH of the pre-pressurized food product is adjusted to a pH between 4.0 and 9.0.

5. The method as claimed in claim 1, wherein the temperature of the food product preprocessed to a temperature between 40 F and 160 F.

6. The method as claimed in claim 1, wherein the food product is maintained at a temperature between 40 F and 120 F during pressurizing.

7. The method as claimed in claim 1, wherein the food product is pressurized to a pressure between 70,000 and 87,000 psi.

8. The method as claimed in claim 7, wherein the food product is maintained at pressure for at least 1 minutes.

9. The method as claimed in claim 1, wherein texture, flavor, aroma, shape and color are minimally affected during the pasteurization process.

10. The method as claimed in claim 1, wherein antimicrobial agents such as Acetates, Benzoates, Diacetates, Dimethyl Dicarbonate, Lactates, Nitrates, Propionates, Sorbates, Sulfites, and carbon dioxide are added to the food product prior to high pressure processing.

11. A system for pressure processing liquid egg product component comprising:
means for adjusting a pH of the liquid egg product component;
means for adjusting a pre-pressurizing temperature of the liquid egg product component;
means for placing the liquid egg product component into a pressure chamber;
means for regulating the temperature of the pressurizing medium;
means for pressurizing the pressure chamber;
means for depressurizing the pressure chamber;
means for evacuating the pressure chamber.

12. The system as claimed in claim 10, wherein the pH of the liquid egg product component is adjusted to between 4.0 and 5.4.

13. The method as claimed in claim 10, wherein antimicrobial agents such as Acetates, Benzoates, Diacetates, Dimethyl Dicarbonate, Lactates, Nitrates, Propionates, Sorbates, Sulfites, and carbon dioxide are added to the food product prior to high pressure processing.

14. The system as claimed in claim 10, wherein the pre-pressurizing temperature of the slurry product component is adjusted to between 40 F and 160 F.

15. The system as claimed in claim 10, wherein the pre-pressurizing temperature of the liquid egg product component is adjusted to between 40 F and 120 F.

16. The system as claimed in claim 10, wherein the pressurizing medium is maintained at a temperature of between 40 F and 120 F.

17. The system as claimed in claim 10, wherein the liquid egg product component is subjected to pressure of between 70,000 psi and 87,000 psi.

18. An apparatus for at least one of batch, continuous flow, semi-continuous flow, and pulse flow High Pressure Pasteurization, which comprises:
a container for at least one of holding, mixing, and pre-heating a pre-pasteurized liquid food material;
a positive displacement pump configured for introducing the liquid food material into a high pressure chamber container;
the high pressure chamber container constructed for pasteurizing the liquid food material;
at least one of: a sterile container for receiving the pasteurized liquid food material; and a star valve for evacuating the liquid food material while maintaining pressure within the high pressure chamber container.

19. An apparatus as claimed in claim 18, where the container for at least one of holding, mixing, and pre-heating the liquid food material is constructed with at least one compartment.

20. An apparatus as claimed in claim 18, wherein the positive displacement pump is constructed with an ambient pressure inlet a high pressure exit and means for attachment at the inlet to said container.

21. An apparatus as claimed in claim 18, further comprising a mechanism configured for creating a suction and pressure at opposite sides of the displacement pump.

22. An apparatus as claimed in claim 18, wherein the positive displacement pump further comprises means for receiving the liquid food material at the inlet.

23. An apparatus as claimed in claim 18, wherein the pressure chamber construction includes a pressurizing media.

24. An apparatus as claimed in claim 23, further comprising means for heating and maintaining temperature of the pressurizing media.

25. An apparatus as claimed in claim 18, further comprising means for increasing pressure within the high-pressure chamber container.

26. An apparatus as claimed in claim 18, wherein the high-pressure chamber container is constructed with a high-pressure inlet and a high pressure outlet.

27. An apparatus as claimed in claim 18, wherein the high-pressure outlet is reduced in diameter from a body of the high-pressure chamber.

28. An apparatus as claimed in claim 18, wherein the high-pressure chamber container is constructed with a first star valve for introducing food product to the high pressure chamber container and a second star valve for evacuating the food product from the high pressure chamber container. Both the first and second star valves working in concert to maintain the pressure integrity of the high pressure chamber container.

29. An apparatus as claimed in claim 18, further comprising a pressure dampening valve at the inlet of the high pressure chamber.

30. An apparatus as claimed in claim 21, further comprising a high pressure valve at the outlet of the high pressure chamber which retains the liquid food material for sufficient time and at sufficient pressure to obtain a log cycle micro-organism reduction for the liquid food material.

31. The apparatus as claimed in claim 24, wherein the high pressure valve controls the flow speed for the liquid food material directly correlating to the sufficient time of the liquid food material at pressure.

32. The apparatus as claimed in claim 20, further comprising depressurizing the liquid food material by directing the liquid food material through a constriction into an area of reduced pressure.

33. The apparatus as claimed in claim 19, where the pressure applied to the liquid food material is between 482 MPa and 600 MPa.

34. The apparatus as claimed in claim 21, where the liquid food material is maintained at the predetermined pressure and for a predetermined time.

35. The apparatus as claimed in claim 23, further comprising: aseptically directing the liquid food material into at least one sterile container.
